(19) United States
(12) Patent Application Publication
(10) Pub. No.: US 2003/0134194 A1
(43) Pub. Date: Jul. 17, 2003

(54) Hermetic seals for lithium-ion batteries

(76) Inventor: Brian J. Lasater, East Wenatchee, WA (US)

Correspondence Address: ALFRED E. MANN FOUNDATION FOR, SCIENTIFIC RESEARCH, PO BOX 905, SANTA CLARITA, CA, 91380, US

(21) Appl. No.: 10/338,369

(22) Filed: Jan. 8, 2003

Related U.S. Application Data
(60) Provisional application No. 60/347,218, filed on Jan. 9, 2002.

(51) Int. Cl. H01M 2/08; H01M 2/30

(52) U.S. Cl. 429/181; 29/623.4; 29/623.2; 174/50.61

(57) ABSTRACT

Advanced implanted medical devices require long-lived, reliable power supplies. Lithium-ion batteries can be used to meet this need if they can be assured of maintaining a hermetic seal while implanted. The invention is a hermetic seal for a lithium-ion battery where the battery header is made of aluminum and the pin is a conventional metal, such as platinum. The glass-to-metal seal utilizes low-temperature processable ALSG-32 glass, which has been demonstrated to bond to aluminum at temperature below the melting point of aluminum and which has been demonstrated to exhibit excellent resistance to lithium battery electrolyte. ALSG-32 is a high phosphate glass having about 6.0% B₂O₃, 40.0% P₂O₅, 15.0% Na₂O, 18.0% K₂O, 9.0% PbO, and 12.0% Al₂O₃, expressed in mole percent.

### CROSS REFERENCE TO RELATED APPLICATION

This application claims the benefit of U.S. Provisional Application No. 60/347,218, filed Jan. 9, 2002.

### FIELD OF THE INVENTION

The present invention is generally directed to forming glass-to-metal seals that are of particular use when hermeticity is required for very long exposures to harsh environments. These seals can be used for the glass-to-metal seals in components exposed to severe chemical environments, e.g., in headers for ambient temperature lithium-ion batteries comprised of aluminum.

### BACKGROUND OF THE INVENTION

The present invention is generally directed to hermetic seals and in particular to hermetic seals that can be used with a lithium-ion battery. A hermetic aluminum seal in lithium-ion batteries is desired. Aluminum is a preferred material in the manufacturing of lithium-ion batteries due to compatibility with the lithium-ion electrolyte. Currently known seals are formed by clamping an aluminum bushing around a polymeric washer, such as PTFE or Teflon®. Teflon is a registered trademark of E. I. du Pont de Nemours and Company. This seal is not truly hermetic and is subject to leaking, especially when under pressure generated during battery operation. What is lacking, therefore, is the ability to form a hermetic aluminum seal that is compatible with battery electrochemistry.

Hermetic seals are often used for harsh environmental applications. They are used to present a barrier that protects sensitive electronic hardware components from outside environmental conditions, which would otherwise destroy the hardware components. In the case of medical devices, hermetic seals can also protect living tissue from electronic components. Hermetic seals must be manufactured as ruggedly as possible for applications where hermeticity will be required for extended exposures to harsh environments.

Ambient temperature lithium-ion batteries provide high energy densities and high rate capabilities at low temperatures; however, a major problem associated with these cells is the highly corrosive nature of lithium battery chemistry. Standard glass electrical insulators, used to separate the header of a battery from the center pin while providing a hermetic seal for the battery, experience extensive corrosion over relatively short periods of time; thus severely limiting the shelf life of the cells.

In order to form an acceptable glass-to-metal seal in an ambient temperature lithium battery, the glass must meet three main criteria. First, it must have a high resistance to lithium corrosion; second, it must be able to make a hermetic seal between the metal header and the metal center pin, which requires a thermal expansion match between the glass and the pin; and, third, it must be an electrical insulator so that the header and the center pin are electrically isolated.

Also, where feedthroughs are utilized in connection with body implanted devices, where the electrical terminals may come into contact with body fluids, it is necessary to choose terminals or pins made of bio-stable materials since there is the possibility of hydrogen embrittlement occurring, especially at the negative terminal in a lithium-ion battery.

One known glass used in the glass-to-metal seal in headers for ambient temperature lithium batteries is TA-23, which has a finite corrosion rate, when in contact with lithium metal, that limits the lifetime of the battery. The sealing temperature of TA-23 is about 1025° C., which is above the melting point of aluminum (which is about 550° C. for typical aluminum alloys).

Glasses based on the CaO—Al₂O₃—B₂O₃ and CaO—MgO—Al₂O₃—B₂O₃ systems have been developed to improve the corrosion resistance and extend the battery lifetime in known designs. A promising glass is Cabal-12, which was developed by Sandia National Laboratories and which exhibits corrosion resistance. Although this glass has desirable corrosion resistance and resistance to cracking, many metals do not wet the glass so as to allow strong, hermetic seals, nor do they exhibit weldability or desired thermal expansion characteristics. Like TA-23, it is designed to have a CTE that closely matches that of the molybdenum center pin, about 6.0×10⁻⁶/° C. Cabal-12 has superior corrosion resistance than TA-23, but all of the CaO—Al₂O₃—B₂O₃ and CaO—MgOAl₂O₃—B₂O₃ glasses have limited CTE ranges, on the order of 6.0-9.0×10⁻⁶/° C., which makes them unsuitable for sealing to high CTE metal pin materials. However, these glasses also seal at temperatures that are above the melting point of aluminum.

U.S. Pat. No. 5,015,530 describes glass-to-metal seals for use in lithium electrolyte environments, using glass compositions that seal hermetically with higher expansion, metal pin materials other than molybdenum. Alkaline earth-aluminoborate glass formulations, based on the (CaO, SrO, BaO)—B₂O₃—Al₂O₃ systems and high thermal expansion metal pin materials are known. The glasses are boroaluminate glasses with SrO and BaO substituted for the CaO and MgO used in Cabal-12, and a CaO—B₂O₃—Al₂O₃ glass, having CTEs that match the pin materials, while resisting attack by lithium. The composition of these glasses is adjusted to achieve a CTE between 9.0 and 12.0×10⁻⁶/° C., allowing hermetic seals to high CTE pin materials, such as 446 stainless steel (CTE of 11.4×10⁻⁶/° C.) and Alloy-52 (CTE of 9.8×10⁻⁶/° C.).

U.S. Pat. No. 5,821,011 addresses a similar problem for body implants of bio-stable materials. The glass insulator is a Cabal-12 type glass. The terminal is comprised of a material that has CTEs compatible with the glass seal. For glass seals having a CTE in the range of 6.8-8.0×10⁻⁶/° C., the terminal is a thin layer of titanium clad over niobium or tantalum. For glass seals having a thermal expansion in the range of 8.0-9.0×10⁻⁶/° C., the terminal is platinum, platinum-iridium, their alloys, or pure titanium.

U.S. Pat. No. 5,851,222 discusses centerless grinding of pins for lithium batteries for implantable medical devices where the pin may be platinum wire, stainless steel, aluminum, tantalum, niobium, or titanium. TA-23 and Cabal-12 sealing glasses are discussed. These known glasses for creating seals in lithium-ion batteries all melt at temperatures that are above the melting point of aluminum alloys.

Hermetic battery seals can also be produced by using a modified aluminoborate composition similar to the family of Cabal-12, wherein the ratio of strontium oxide and/or barium oxide may be adjusted to maximize the coefficient of thermal expansion. Glasses described by Wilder (see, e.g., U.S. Pat. No. 4,202,700) and Day, et al. (see, e.g., U.S. Pat. No. 4,455,384) may alternatively be used to form a hermetic seal with aluminum, but their compatibility in the lithium-battery electrolyte is unknown.

A sealing glass that will seal with aluminum and that is compatible with the lithium battery environment is needed.

### SUMMARY OF THE INVENTION

The present invention is directed to the formation of glass-to-metal seals in a lithium-ion battery having a lightweight, reliable body, such as an aluminum body, for applications when hermeticity must be retained for long exposures to harsh environments.

Lithium-ion batteries, for example, contain a very corrosive electrolyte. A lithium-ion battery in a conventional application may not require true hermeticity because the battery will “wear out” before the seal does. However, the use of these batteries for rechargeable applications demands that the battery remain hermetically sealed and that the battery keep the electrolyte from escaping the battery package for longer terms. In other hermetic applications, such as seawater, saline, in vivo and/or implantable devices and the like, a long-lived reliable hermetic seal is essential.

Creating a glass seal of ALSG-32 glass, having a composition expressed in mole percent, of about 6.0% B₂O₃, 40.0% P₂O₅, 15.0% Na₂O, 18.0% K₂O, 9.0% PbO, and 12.0% Al₂O₃, with a metal pin of known composition and an aluminum body leads to a long-lived, reliable lithium-ion battery hermetic seal. Such a seal is essential to the application of lithium batteries to implantable devices in living tissue.

The novel features of the invention are set forth with particularity in the appended claims. The invention will be best understood from the following description when read in conjunction with the accompanying drawings.

### OBJECTS OF THE INVENTION

It is an object of the invention to bond a metal pin in an aluminum header with a glass-to-metal seal for use in corrosive environments.

It is an object of the invention to achieve a glass-to-metal seal with an aluminum header in a lithium-ion battery.

Other objects, advantages and novel features of the present invention will become apparent from the following detailed description of the invention when considered in conjunction with the accompanying drawing.

### BRIEF DESCRIPTION OF THE DRAWINGS

FIG. 1 is cross-sectional view through a feedthrough in a lithium-ion battery.

### DETAILED DESCRIPTION OF THE PREFERRED EMBODIMENT

The following description is of the best mode presently contemplated for carrying out the invention. This description is not to be taken in a limiting sense, but is made merely for the purpose of describing the general principles of the invention.

The present invention is directed to improved techniques for generating a hermetic seal that is particularly rugged, such that hermeticity can be maintained for extended periods in harsh environments, such as lithium-ion batteries in implanted medical devices in living tissue.

Glass sealing material has been produced, having been designated as ALSG-32, (see, e.g., U.S. Pat. No. 5,262,364 to Brow, et al.) that is suitable for sealing to aluminum. These glasses are further discussed in L. Kovacic, S. V. Crowder, R. K. Brow, and D. N. Bencoe, “Designing Aluminum Sealing Glasses for Manufacturability,” Cer. Trans., 50 95-107. Lithium-ion battery seals containing high amounts of silica are more corrosion prone during exposure to the electrolyte than seals that do not contain silica. ALSG-32 contains no silica. However, ALSG-32 is a phosphate-based glass and there is no known prior art or teaching the use of phosphate glasses in batteries. This invention applies the ALSG-32 glasses as a sealing material in a lithium-ion battery, wherein at least one of the materials that forms the seal is a preferred material such as aluminum or an aluminum alloy.

A further embodiment of this invention is to modify the ALSG-32 with up to 50 mole percent MgO, which is known to be highly resistant to hydrofluoric acid in the battery electrolyte. This approach to eliminate or significantly reduce seal corrosion due to battery electrolyte is disclosed. Kilgo, et al. (see, e.g., U.S. Pat. Nos. 5,965,469 and 6,037,539) describe modified versions of this glass that have a reduced dielectric constant. The glass compositions developed by Kilgo, et al. may also be used for batteries. The ALSG-32, and modified versions thereof, have been used as electrical feedthrough seals in connectors for electronic packaging. Additionally, they have been used as RF feedthroughs. However, the inventor is unaware of any prior discussion or use of these glasses as battery seals. In addition to these glasses, others glasses having variation of the ALSG-32 composition may also be used.

Exemplary materials of construction for batteries that may be used with the present invention are:

Header:

Aluminum or aluminum alloys

Titanium-aluminum alloys

Stainless steel 300 series

Copper or copper alloys

Glass:

ALSG-32 or variants thereof

Phosphate glasses in general, preferably lead-free glasses, as described by the Kilgo, et al. patents

Pin-conductor:

Copper or copper alloys

Nickel and nickel alloys

Stainless steels, e.g. 300 series, 400 series

Titanium, niobium, tantalum, molybdenum, and alloys thereof

Platinum, iridium, rhodium, rhenium, and alloys thereof

Aluminum or aluminum alloys

To evaluate the glass-electrolyte compatibility, a sample if ALSG-32 glass was placed in lithium battery electrolyte at room temperature in an unagitated container of typical lithium-ion solution for 40 days by the inventor. No weight loss, no visual change, or other indicia of corrosion were observed.

The preferred composition of ALSG-32 glass, in mole percent, is about 6.0% B₂O₃, 40.0% P₂O₅, 15.0% Na₂O, 18.0% K₂O, 9.0% PbO, and 12.0%Al₂O₃. This composition is reported by R. K. Brow, L. Kovacic, and R. E. Loehman, “Novel Glass Sealing Technologies,” International Symposium on Manufacturing Practices and Technology, Fall Meeting of the American Ceramic Society, New Orleans, La., Nov. 5-8, 1996.

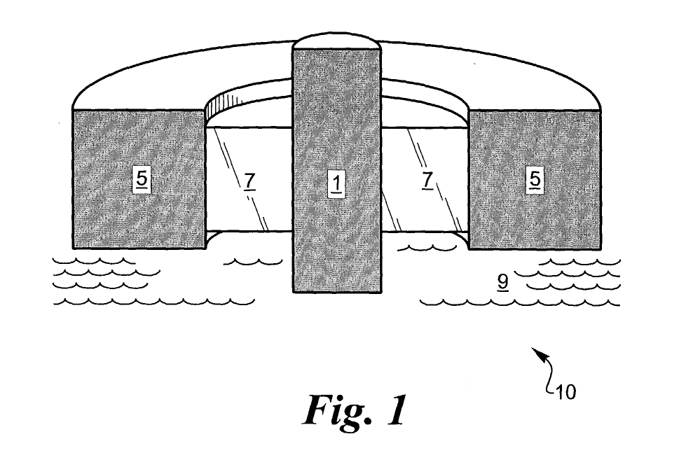

FIG. 1 provides a cross-sectional view of a preferred embodiment of the bonded assembly 10. The bonded assembly 10 is representative of a glass-to-metal seal for a lithium-ion battery, where the lithium electrolyte 9 is isolated from the ambient environment by hermetic seals between a sealing glass 7 and a pin 1, as well as between the sealing glass 7 and the header 5, where the header 5 is a preferably a metallic body component comprised of a chemically resistant metal. The header 5 is preferably comprised of aluminum, which is known to be compatible with lithium battery electrolyte. Pin 1 is retained in place by sealing glass 7, which electrically insulates the pin 1 from the header 5. The pin is preferably comprised of an electrical conductor, such as copper or copper alloys, nickel and nickel alloys, stainless steels, e.g., 300 series, 400 series, titanium, niobium, tantalum, molybdenum, and alloys thereof; platinum, iridium, rhodium, rhenium, and alloys thereof; or aluminum or aluminum alloys.

Obviously, many modifications and variations of the present invention are possible in light of the above teachings. It is therefore to be understood that, within the scope of the appended claims, the invention may be practiced otherwise than as specifically described.

What is claimed is:

1. A component assembly having a glass-to-metal seal for use in conjunction with a lithium-ion electrolyte, comprising:
a metallic body component comprised of a chemically resistant metal;
a chemically resistant metallic electrically conductive pin; and
a glass material disposed between and electrically insulating said metallic body component from said pin, said glass material being chemically resistant to said lithium-ion electrolyte.

2. The component assembly according to claim 1, wherein said lithium-ion electrolyte is contained within a battery.

3. The component assembly according to claim 2, wherein said battery is suitable for implantation in living tissue.

4. The component assembly according to claim 1, wherein said glass material is comprised of about 6.0% B₂O₃, 40.0% P₂O₅, 15.0% Na₂O, 18.0% K₂O, 9.0% PbO, and 12.0% Al₂O₃, expressed in mole percent.

5. The component assembly according to claim 1, wherein said metallic body component is comprised of aluminum.

6. A method of forming a component assembly with lithium-ion electrolyte, comprising:
providing a metallic body component that has a melting point;
providing a high phosphate glass seal material having a sealing temperature that is below the melting point of said body component;
providing a pin material;
selecting said pin material from the group consisting of platinum, iridium, platinum-iridium, and platinum alloy;
forming a bonded assembly by heating said pin, said body, and said glass seal at a temperature above said sealing temperature of said glass seal material and that is below said melting point of said body material; and
causing said assembly to cool to room temperature.

7. The method according to claim 6, wherein said metallic body component is selected from the group comprising aluminum and aluminum alloys.
